(19) United States
(12) Patent Application Publication
(10) Pub. No.: US 2010/0086079 A1
(43) Pub. Date: Apr. 8, 2010

(54) APPARATUS AND METHOD FOR PROVIDING DIGITAL BROADCAST INFORMATION IN MOBILE TERMINAL

(75) Inventor: Bu-Seop JUNG, Suwon-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/534,444

(22) Filed: Aug. 3, 2009

(30) Foreign Application Priority Data
Oct. 8, 2008 (KR) 10-2008-0098666

(51) Int. Cl. H04L 27/00

(52) U.S. Cl. 375/295

(57) ABSTRACT

An apparatus and a method for providing digital broadcasting information in a mobile terminal are provided. The apparatus includes a channel list manager for setting a channel list according to an actual burst transmission order, and a controller for performing a process to sequentially search for channels of the set channel list using a plurality of players.

### PRIORITY

This application claims the benefit under 35 U.S.C. §119(a) of a Korean patent application filed in the Korean Intellectual Property Office on Oct. 8, 2008 and assigned Serial No. 10-2008-0098666, the entire disclosure of which is hereby incorporated by reference.

### BACKGROUND OF THE INVENTION

1. Field of the Invention

The present invention relates to a mobile terminal which can receive digital broadcasting. More particularly, the present invention relates to an apparatus and a method for generating an arbitrary channel list and sequentially outputting data while a mobile terminal receives digital broadcasting.

2. Description of the Related Art

Mobile terminals have developed rapidly to provide wireless voice communication and information exchange that has become a necessity of daily life. In an early distribution stage, the mobile terminals have been recognized simply as terminals which can be carried and provide wireless communication. As technology of the mobile terminals develop and the wireless Internet is introduced, the mobile terminals not only provide simple telephone conversation or schedule management but also extend their utilization range by providing games, remote control of short range communication, and camera functions using a mounted digital camera module.

Recently, as digital broadcast technology develops, mobile terminals support a digital broadcast receiving function to allow a user to view digital multimedia broadcasting while moving.

The digital broadcast technology includes a Digital Video Broadcasting-Handheld (DVB-H) technique which evolved from a DVB-Terrestrial (T) standard. The DVB-H, which maintains compatibility with the DVB-T, has been established with consideration of miniaturization, lightweight characteristics, portability, and low power consumption characteristics of a terminal suitable for a concept of a mobile broadcast service.

A time slicing technique of technical characteristics of the DVB-H is a multiplexing scheme for dividing a capacity of a transmission line into a predetermined number of time slots, and conveying a packetized broadcast signal on each time slot. Mobile terminals may operate a receiver during only a specific time slot and suspend operation of the receiver during the remaining time slots by determining a reception time of next data using a delta-T value of a Multi-Protocol Encapsulation (MPE) header to reduce power consumption.

However, the above-described method has a limitation that when a user of the mobile terminal requests a change of channel which is being reproduced, the changing of the channel consumes a lot of time.

For example, in a case where a user who receives data of channel 2 intends to change to channel 6, the mobile terminal must wait for burst reception sections corresponding to channels 3, 4 and 5, and then perform a channel change to channel 6. Also, in the case where a user who receives data of channel 2 performs a channel change to channel 3, which is the next channel, when a point at which the user desires to change the channel is a point past a data reception section corresponding to channel 3, the user must wait by a time of delta-T and then perform the channel change to channel 3.

Therefore, in the case where the user of the mobile terminal intends to determine which broadcasts are transmitted by other channels while viewing an arbitrary channel, the user sequentially changes channels using a separate channel change key to determine broadcasting contents of a relevant channel.

The channel change time includes a time (i.e., an additional time for initializing a player and performing buffering at a decoder) required for driving a relevant application in addition to a time of a maximum delta-T. Accordingly, sequentially searching for all channels causes inconvenience to the user of the mobile terminal.

Also, the mobile terminal conventionally provides a list of channels received by the mobile terminal using information of an Electronic Service Guide (ESG). The ESG includes a channel number and a channel name, and includes information representing a relationship between an actual burst and a Packet IDentifier (PID).

At this point, since an order of bursts to be actually transmitted and an order of a channel list through the ESG do not coincide with each other, channel searching from the receiver results in an inconvenience for users.

Therefore, a need exists for an apparatus and method for preventing a delay of a channel search in a mobile terminal receiving digital broadcasting.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for preventing a channel search delay in a mobile terminal which can receive digital broadcasting.

Another aspect of the present invention is to provide an apparatus and a method for performing a channel search process sequentially using a plurality of players in a mobile terminal which can receive digital broadcasting.

Still another aspect of the present invention is to provide an apparatus and a method for generating a channel list according to an actual burst order, and performing a channel search process according to an order of the generated channel list in a mobile terminal which can receive digital broadcasting.

In accordance with an aspect of the present invention, an apparatus for providing digital broadcasting information in a mobile terminal is provided. The apparatus includes a channel list manager for setting a channel list according to an actual burst transmission order, and a controller for performing a process to sequentially search for channels of the set channel list using a plurality of players.

In accordance with another aspect of the present invention, a method for providing digital broadcasting information in a mobile terminal is provided. The method includes setting a channel list according to an actual burst transmission order, and automatically and sequentially searching for channels of the set channel list using a plurality of players.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram illustrating a mobile terminal for performing a process of searching for channels of digital broadcasting according to an exemplary embodiment of the present invention;

FIG. 2 is a flowchart illustrating a process of searching for channels of digital broadcasting in a mobile terminal according to an exemplary embodiment of the present invention;

FIG. 3 is a flowchart illustrating a process of outputting data according to channel searching in a mobile terminal according to an exemplary embodiment of the present invention;

FIG. 4 illustrates a channel search process of a mobile terminal according to an exemplary embodiment of the present invention; and

FIG. 5 illustrates a construction of a channel list generated by a mobile terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention will be described herein below with reference to the accompanying drawings. In the following description, well-known functions or constructions are not described in detail since they would obscure the invention in unnecessary detail.

Exemplary embodiments of the present invention provide an apparatus and a method for performing a process of automatically searching for channels sequentially using a plurality of players in order to prevent a channel search delay in a mobile terminal which can receive digital broadcasting.

Here, digital broadcasting may include Digital Multimedia Broadcasting (DMB), Digital Video Broadcasting (DVB), Digital Audio Broadcasting (DAB), and the like.

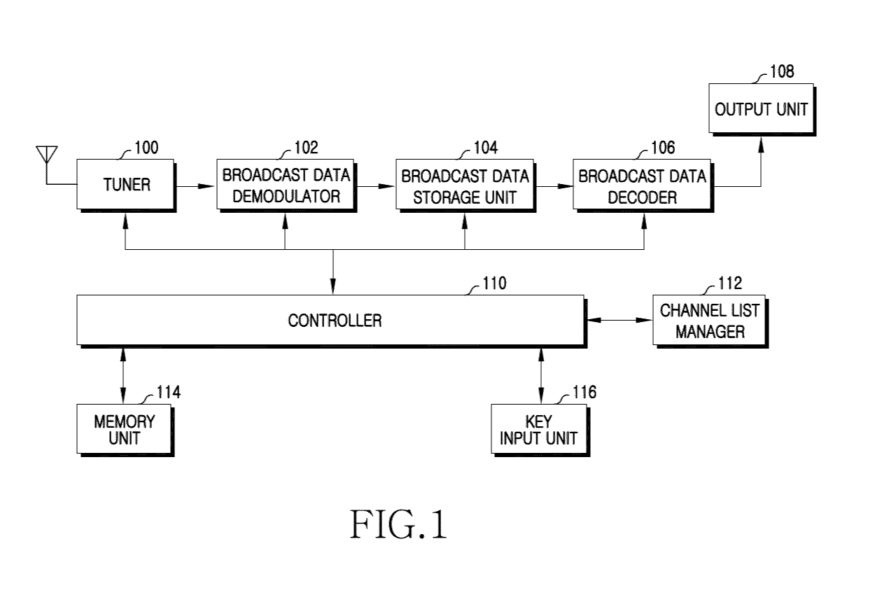

FIG. 1 is a block diagram illustrating a mobile terminal for performing a process of searching for channels of digital broadcasting according to an exemplary embodiment of the present invention.

Referring to FIG. 1, the mobile terminal includes a tuner 100, a broadcast data demodulator 102, a broadcast data storage unit 104, a broadcast data decoder 106, an output unit 108, a controller 110, a channel list manager 112, a memory unit 114 and a key input unit 116. The tuner 100, the broadcast data demodulator 102, the broadcast data storage unit 104 and the broadcast data decoder 106 define a digital broadcast processor.

The tuner 100 of the digital broadcast processor sets a physical channel frequency of a service channel selected by a user and receives broadcast signals of the set physical channel under control of the controller 110. The broadcast data demodulator 102 demodulates the broadcast signals of the physical channel output from the tuner 100. At this point, the broadcast data demodulator 102 demodulates signals of a plurality of service channels included in the physical channel. The broadcast data storage unit 104 buffers data of a service channel selected from data of service channels output from the broadcast data demodulator 102 and data of at least one different service channel to be used during a broadcast channel change. The broadcast data decoder 106 decodes and outputs signals of a service channel selected by the user.

The controller 110 of the mobile terminal controls an overall operation of the mobile terminal. For example, the controller 110 performs a process and a control for voice communication and data communication. More particularly, the controller 110 performs a channel search process sequentially using a plurality of players in order to prevent a channel search delay.

That is, the controller 110 controls the digital broadcast processor to generate a channel list according to an actual burst order and to perform a channel search process according to an order of the generated channel list.

The channel list manager 112 determines a transmission order of an actual burst using Program Specific Information (PSI) including channel list information, and generates a channel search order corresponding to the determined actual burst transmission order.

The memory unit 114 may include a Read Only Memory (ROM), a Random Access Memory (RAM), a flash ROM, and the like. The ROM may store a microcode of a program for process and control of the controller 110, and various reference data.

The RAM serves as a working memory of the controller 110, and may store temporary data generated while various programs are executed. Also, the flash ROM may store updatable various data for storage, such as, a phone book, an originating message, a received message, and the like.

The key input unit 116 may include a plurality of function keys, such as, numerical key buttons 0 to 9, a menu button, a cancel (delete) button, an OK button, a TALK button, an END button, an Internet connection button, navigation key (or direction key) buttons, letter key buttons, and the like. The key input unit 116 provides key input data (e.g., a channel search request, and the like) corresponding to a key pressed by a user to the controller 110.

The output unit 108 displays information, a limited number of letters, a large amount of moving images and still images generated during an operation of the mobile terminal. For the output unit 108, a color Liquid Crystal Display (LCD) may be used. In an exemplary implementation, the output unit 108 outputs data corresponding to channel search using a plurality of players, that is, a plurality of output screens.

A function of the channel list manager 112 may be performed by the controller 110 of the mobile terminal. The illustrated separate configuration of the channel list manager 112 is exemplary for convenience of description and does not limit the scope of the present invention. However, various modifications may be made within the scope of the present invention. For example, all or some of the functions of the channel list manager 112 may be processed by the controller 110.

A description has been made above of an exemplary apparatus for performing a channel search process sequentially using a plurality of players in order to prevent a channel search delay in a mobile terminal which may receive digital broadcasting. Hereinafter, a description will be made of a method for preventing a channel search delay in a mobile terminal which may receive digital broadcasting using the above-described apparatus according to an exemplary embodiment of the present invention.

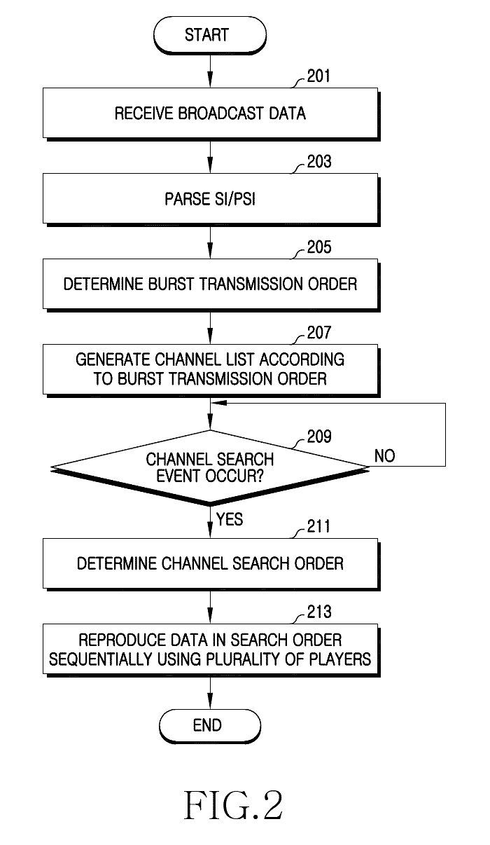

FIG. 2 is a flowchart illustrating a process of searching for channels of digital broadcasting in a mobile terminal according to an exemplary embodiment of the present invention.

Referring to FIG. 2, in step 201, the mobile terminal receives digital broadcasting, that is, bursts. In step 203, the mobile terminal parses Service Information (SI)/PSI information required for generating a channel list.

Accordingly, in step 205, the mobile terminal determines a burst transmission order using the SI/PSI information. Here, the mobile terminal may determine an actual burst transmission order using a timer for a time slicing operation. The operation process of the mobile terminal which determines the transmission order of the actual burst is briefly described below.

The mobile terminal determines and stores reception times of arbitrary filterable Packet IDentifiers (PIDs) of PIDs existing inside a Transport Stream (TS) packet stream, and determines reception times of other PIDs except for the PIDs that determine a transmission order of an actual burst. An exemplary method for determining a transmission order of an actual burst is disclosed in Applicant's Korean patent application No. 10-2007-0133644, the entire disclosure of which is hereby incorporated by reference, and a detailed description of which is omitted for conciseness.

In step 207, the mobile terminal re-generates a channel list according to the transmission order of the actual burst determined in step 205. In step 209, the mobile terminal determines whether a channel search event occurs. Here, the channel search event denotes an event for determining information of programs broadcast by other channels while a user of the mobile terminal views digital broadcasting currently being received. At this point, the mobile terminal may include a separate key for channel search, and a separate key for determining a channel search direction (e.g., a right key for searching in a forward direction, a left key for searching in a reverse direction, and the like).

If it is determined that the channel search event does not occur, the mobile terminal performs step 209 again in order to perform a process of determining whether the event occurs.

If it is determined that the channel search event occurs, the mobile terminal determines a channel search order in step 211. Here, the channel search order denotes searching channels in a forward direction or a reverse direction from one channel of the channel list generated in step 207. The order may be determined by key input of the user of the mobile terminal.

Since the broadcast data demodulator 102 of the mobile terminal recognizes in advance the next service channel to be received based on the channel list generated in step 207, the broadcast data demodulator 102 may automatically prepare to receive the next channel burst based on a current reproduction channel even without selection by a user.

In step 213, the mobile terminal performs a process of searching for relevant channels sequentially using a plurality of players, as described below.

Assuming that the mobile terminal may drive two players, i.e., a main player and another player (e.g., a Picture-In-Picture (PIP) function), the mobile terminal searches for one channel using the main player and searches for the next channel using the other player (i.e., the PIP player).

A point at which the other player (i.e., the PIP player) is driven, after the main player is driven, is a point past a time (i.e., additional time for initializing the PIP player and performing buffering at a decoder) required for driving the other player (i.e., the PIP player), after the main player is driven. After the other player (i.e., the PIP player) is driven, the driving of the main player is stopped.

By searching for all channels using this method, a stand-by time generated during a channel change in a conventional channel search process may be replaced by a predefined reproduction time of each channel. Therefore, a user may automatically search for channels without having to wait until the next channel is reproduced.

After that, the mobile terminal ends the present algorithm.

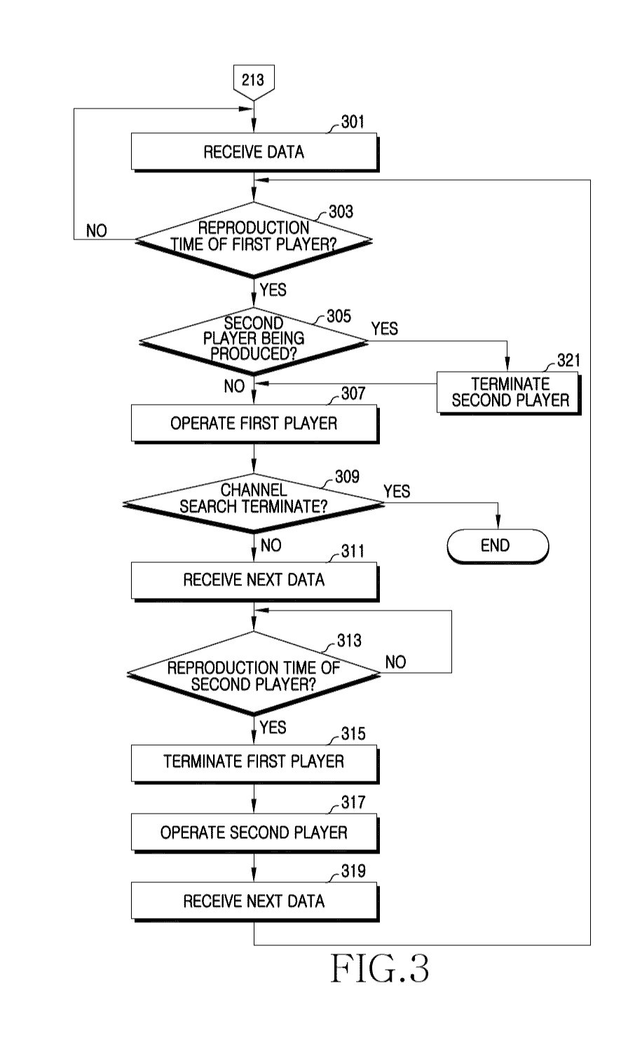

FIG. 3 is a flowchart illustrating a process of outputting data according to channel search in a mobile terminal according to an exemplary embodiment of the present invention. Here, a description is made based on the assumption that the mobile terminal may receive digital broadcasting by driving two players, that is, using two screens.

Referring to FIG. 3, in step 301, the mobile terminal receives data. In step 303, the mobile terminal determines whether the data is a first player reproduction time. Here, the first player reproduction time denotes a time (i.e., additional time for initializing the first player and performing buffering at a decoder) required for driving the first player.

If it is determined that the data is not the first player reproduction time, the mobile terminal performs step 301.

If it is determined that the data is the first player reproduction time, the mobile terminal determines whether a second player is performing reproduction in step 305.

If it is determined that the second player is not performing reproduction in step 305, the mobile terminal operates the first player in step 307.

If it is determined that the second player is performing reproduction in step 305, the mobile terminal terminates the reproduction of the second player which is performing the reproduction in step 321, and operates the first player in step 307.

In step 309, the mobile terminal, which has operated the first player, determines whether a channel search terminate request is detected.

If the channel search terminate request is detected in step 309, the mobile terminal ends the present algorithm.

If the channel search terminate request is not detected in step 309, the mobile terminal receives next data, that is, broadcasting of a channel next to the channel which is currently being reproduced among channels included in a channel list in step 311, and determines whether the next data is a second player reproduction time in step 313. The second player reproduction time denotes a time (i.e., additional time for initializing the second player and performing buffering at a decoder) required for driving the second player.

If it is determined that the next data is not the second player reproduction time in step 313, the mobile terminal performs step 313 again.

If it is determined that the next data is the second player reproduction time in step 313, the mobile terminal terminates the first player which is performing reproduction in step 315, and operates the second player in step 317.

A point at which the second player performs reproduction is a point past a time (i.e., additional time for initializing the PIP player and performing buffering at a decoder) required for driving the second player, after the first player is driven. After the second player is driven, the driving of the first player is stopped.

In step 319, the mobile terminal receives the next data, and repeatedly performs step 303.

That is, when performing a channel search process, the mobile terminal reproduces broadcasting of a relevant channel sequentially using respective players.

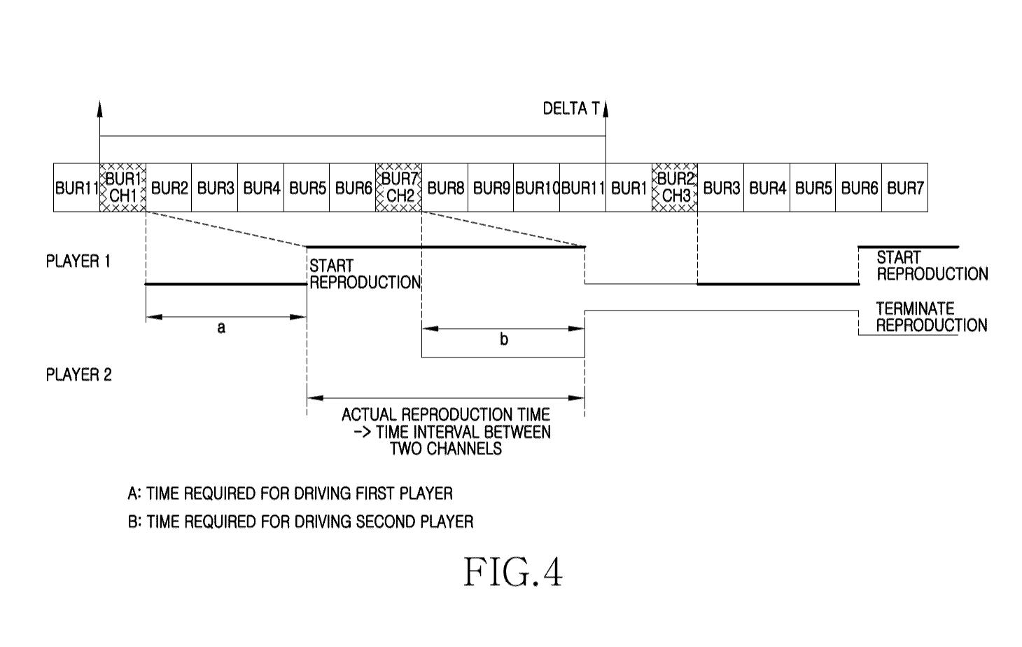

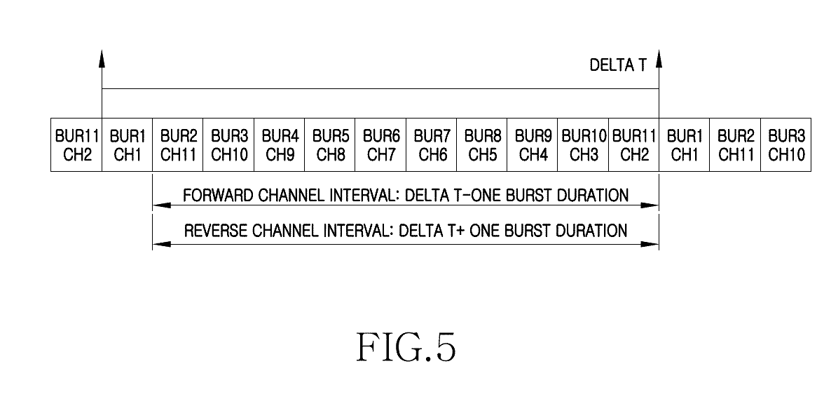

FIG. 4 is a view illustrating a channel search process of a mobile terminal according to an exemplary embodiment of the present invention. In the description below, FIG. 5 is a view illustrating a construction of a channel list generated by a mobile terminal according to an exemplary embodiment of the present invention.

Referring to FIG. 4, the mobile terminal determines a burst transmission order and generates a channel list which depends on a burst transmission speed.

As illustrated in FIG. 4, it is assumed herein that the mobile terminal sets channel 1 at burst 1, and channel 2 at burst 7. When determining an order of each channel, the mobile terminal sets the order of each channel such that actual bursts are arranged with a constant interval.

When performing an automatic channel search process, the mobile terminal reproduces data of channel 1 using a first player 1. At this point, a reproduction point of the first player 1 is a point past a time ‘a’ including a time for initializing the first player and a delay at a different application after burst 1 corresponding to the order in which channel 1 is received.

The mobile terminal reproduces data of channel 2 with a second player 2 using the above-described method. At this point, a reproduction point of the second player 2 is a point past a time ‘b’ including a time for initializing the second player 2 and a delay at a different application after burst 7 corresponding to the order in which channel 2 is received.

That is, the mobile terminal outputs data for channel 1 using the first player 1, and then reproduces data for channel 2 using the second player. The mobile terminal then outputs data for channel 3 using the first player 1. The operation of the first player 1 terminates at a point at which the second player operates after the first player 1 operates. In other words, the mobile terminal sequentially operates the first player 1 and the second player 2. The two players do not operate simultaneously, but operate sequentially.

Also, the mobile terminal may search for channels in a forward direction or in a reverse direction.

For this purpose, the mobile terminal may configure channels as in FIG. 5 with consideration of channel orders which may be arranged with equal intervals in both directions, that is, a forward direction and a reverse direction.

Referring to FIG. 5, since an actual burst length may change every delta T, when channels are arranged with an interval of delta T/2, a constant reproduction time of each channel cannot be maintained. Such a limitation may be resolved by maintaining a constant reproduction time of each channel using a timer and buffering from a player. However, in a case where channels are arranged such that an interval between respective channels is about delta T−one burst interval, since the length of one burst has little deviation while the delta T value is constant, an almost constant reproduction time may be guaranteed.

As illustrated in FIG. 5, arranging channels such that an interval of each channel is delta T−one burst interval is similar to a case of determining a channel order as a reverse direction of an actual burst order. In a case of searching in a forward direction from channel 1, a channel reproduction time becomes delta T−one burst interval. In a case of searching in a reverse direction which moves from channel 1 to channel 11, a channel reproduction time becomes delta T+one burst interval. Although channel 11 exists next to channel 1 during the search in the reverse direction, the mobile terminal ignores a burst of channel 11 entering next to channel 1 in order to guarantee a constant channel reproduction in the search in the forward direction.

The above-described channel search order, that is, the forward direction channel search or the reverse direction channel search may be selected by inputting a separate key (e.g., a left arrow, a right arrow, and the like) provided to the mobile terminal.

As described above, a mobile terminal according to an exemplary embodiment of the present invention addresses a channel search delay generated during reception of digital broadcasting by automatically performing a channel search process sequentially using a plurality of players in order to prevent the channel search delay. Also, an exemplary embodiment of the present invention may resolve inconvenience generated by non-coincidence between an order of an actually transmitted burst and an order of a channel list through an Electronic Service Guide (ESG).

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for providing digital broadcasting information in a mobile terminal, the apparatus comprising:
a channel list manager for setting a channel list according to an actual burst transmission order; and
a controller for performing a process to sequentially search for channels of the set channel list using a plurality of players.

2. The apparatus of claim 1, wherein the controller generates the set channel list according to the actual burst transmission order.

3. The apparatus of claim 1, wherein the controller allows a channel search order to be selected to search for channels in at least one of a forward direction and a reverse direction.

4. The apparatus of claim 3, wherein the controller repeatedly performs a process of reproducing one of the channels which have been set according to the actual burst transmission order using a first player, and receiving data of a next channel during an operation of the first player to reproduce the data using a second player until all of the channels are searched.

5. The apparatus of claim 4, wherein, after receiving data of a relevant channel, the controller operates the plurality of players after a time for initializing a player and a delay at a different application expires.

6. The apparatus of claim 5, wherein the plurality of players comprises a plurality of output screens.

7. The apparatus of claim 5, wherein the controller performs a process such that the first player and the second player operate in turns and not simultaneously.

8. The apparatus of claim 7, wherein the first player and the second player comprises a first output screen and a second output screen, respectively.

9. The apparatus of claim 1, wherein the channel list manager determines the actual burst transmission order using Program Specific Information (PSI) comprising channel list information.

10. A method for providing digital broadcasting information in a mobile terminal, the method comprising:
setting a channel list according to an actual burst transmission order; and
automatically and sequentially searching for channels of the set channel list using a plurality of players.

11. The method of claim 10, wherein the set channel list is generated according to the actual burst transmission order.

12. The apparatus of claim 10, wherein the plurality of players comprises a plurality of output screens.

13. The method of claim 10, wherein the sequentially searching of the channels comprises allowing a channel search order to be selected to search for the channels in at least one of a forward direction and a reverse direction.

14. The method of claim 13, wherein the sequentially searching of the channels further comprises:
reproducing one of the channels which have been set according to the actual burst transmission order using a first player;
receiving data of a next channel during an operation of the first player to reproduce the data using a second player; and
repeatedly performing on all the channels the reproducing of one of the channels which have been set according to the actual burst transmission order using the first player and the receiving of the data of the next channel during the operation of the first player to reproduce the data using the second player.

15. The method of claim 14, wherein the sequentially searching of the channels is performed after data of a relevant channel is received, and a time for initializing a player and a delay at a different application expires.

16. The method of claim 15, wherein the sequentially searching of the channels comprises operating the first player and the second player in turns and not simultaneously.

17. The apparatus of claim 16, wherein the first player and the second player comprises a first output screen and a second output screen, respectively.

18. The method of claim 10, wherein the actual burst transmission order is determined using Program Specific Information (PSI) comprising channel list information.

19. A method for providing digital broadcasting information in a mobile terminal, the method comprising:
means for setting a channel list according to an actual burst transmission order; and
means for sequentially searching for channels of the set channel list using a plurality of players.
